(19) United States
(12) Patent Application Publication
(10) Pub. No.: US 2026/0147601 A1
(43) Pub. Date: May 28, 2026

(54) ADAPTIVE MODIFICATION OF VIRTUAL MACHINE CONNECTIVITY BASED ON PREDICTED ACTIVE PERIODS

(71) Applicant: Microsoft Technology Licensing, LLC, Redmond, WA (US)

(72) Inventors: German David OBANDO CHACON, Kirkland, WA (US); Arber HILA, Seattle, WA (US); Antonella María AVOGADRO AMADEI, Redmond, WA (US); Dhruv Chand MUTTARAJU, Seattle, WA (US); Lei TIAN, Bellevue, WA (US); Trent Jarvis BYFIELD, Seattle, WA (US); Jacob Scott FULLERTON, Seattle, WA (US)

(21) Appl. No.: 18/963,404

(22) Filed: Nov. 27, 2024

(51) Int. Cl. G06F 9/455

(52) U.S. Cl. CPC G06F 9/45558; G06F 2009/45595

(57) ABSTRACT

A system may receive current virtual machine information including virtual machine configuration parameters of the virtual machine and current activity data of the virtual machine, wherein the current activity data includes a current operating state of the virtual machine. The system may input the current virtual machine information into an artificial intelligence model, wherein the artificial intelligence model is trained to infer periods of active demand of the virtual machine using training data, including historical virtual machine configuration parameters and historical activity data of the virtual machine corresponding to historical periods of active demand of the virtual machine. The system may infer a period of active demand of the virtual machine by executing the artificial intelligence model on the current virtual machine information. The system may change the virtual machine to a new operating state based on the inferred period of active demand.

### BACKGROUND

Cloud computing platforms provide processing resources to end customers. These processing resources are, for example, provided as virtual machines (VMs) hosted by physical servers located at data centers. An end customer commonly interacts, using a client computing device, with a cloud computing platform to access a VM that executes various processing jobs.

### SUMMARY

In some aspects, the techniques described herein relate to a method for managing operating states of a virtual machine operating on a cloud computing system, the method including: receiving current virtual machine information including virtual machine configuration parameters of the virtual machine and current activity data of the virtual machine, wherein the current activity data includes a current operating state of the virtual machine; inputting the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine; inferring a period of active demand of the virtual machine by receiving an output of the artificial intelligence model; and changing the virtual machine to a new operating state based on the inferred period of active demand.

In some aspects, the techniques described herein relate to one or more tangible processor-readable storage media embodied with instructions for executing on one or more processors and circuits of a computing device a process for managing operating states of a virtual machine operating on a cloud computing system, the process including: receiving current virtual machine information including virtual machine configuration parameters of the virtual machine and current activity data of the virtual machine, wherein the current activity data includes a current operating state of the virtual machine; inputting the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine; inferring a period of active demand of the virtual machine by receiving an output of the artificial intelligence model; and changing the virtual machine to a new operating state based on the inferred period of active demand.

In some aspects, the techniques described herein relate to a computing system for managing operating states of a virtual machine operating on a cloud computing system, the computing system including: one or more hardware processors; a usage monitor executable by the one or more hardware processors and configured to receive current virtual machine information including virtual machine configuration parameters of the virtual machine and current activity data of the virtual machine, wherein the current activity data includes a current operating state of the virtual machine; an active demand predictor executable by the one or more hardware processors and configured to: input the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine; and infer a period of active demand of the virtual machine by receiving an output of the artificial intelligence model; and an operation modifier executable by the one or more hardware processors and configured to change the virtual machine to a new operating state based on the inferred period of active demand.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example computing environment in which an adaptive VM uptime scheduler (AVMUS) of a cloud computing system manages an operating state of a VM that is configured to connect to a client computing device.

FIG. 2 illustrates an example computing environment for training an active demand period predictor model (ADPPM) configured to infer one or more periods of active demand of a VM.

FIG. 3 illustrates an example computing environment in which an adaptive VM uptime scheduler (AVMUS) of a cloud computing system manages an operating state of a VM.

FIG. 4 illustrates examples of operations for managing operating states of a virtual machine operating on a cloud computing system.

FIG. 5 illustrates an example computing device for implementing the described technology.

### DETAILED DESCRIPTION

Cloud computing systems commonly transition VMs to an operating state that consumes less energy than a current operating state during periods of anticipated nondemand by client computing devices to reduce power consumption. For example, cloud computing systems may transition a VM that is in active demand to a power-saving or cost-saving operating state (e.g., sleep, hibernation, or deactivation operating state) during nonworking hours, holidays, or during other predefined periods of time.

However, significant inefficiencies remain when applying power usage or cost usage reduction schemes involving transitioning VMs to power-saving or cost-saving operating states (e.g., sleep, hibernation, deactivation) for predefined periods. In some instances, the client computing device may request processing from the VM when the VM is in a power-saving or cost-saving operating state and face a delay resulting from waking, reactivating, or restoring, respectively, the VM prior to the VM performing the requested processing. For example, reactivating a deactivated VM may involve restarting the VM, restoring its resources (e.g., CPU, memory, etc.), reconnecting network interfaces, and/or other processes needed to restore the VM's full functionality. Restoring a hibernating VM may involve loading its saved memory state and reactivating its resources to resume operations where it left off at the time hibernation began. In some instances, an active VM wastes computing resources when the client computing device does not demand processing from the VM for a significant period of time while the VM is active.

Depending on the circumstances of how the VM deprovisioned, as well as the amount of memory present in the system, a user of a client computing device attempting to connect to the VM and access services provided by the VM could be waiting well above 10 minutes to re-gain access to their workstation while it starts. On occasion, a client computing device will also be deprovisioned when a user leaves the system idle (e.g., perhaps by disconnecting their remote session, or simply by not having any keyboard, mouse, or input device interaction with the workstation) and they will have to wait for it to become available again should they need access to it. Cloud computing system technologies are inadequate for reducing power consumption while also minimizing latency because they merely implement predefined activation/deactivation schedules for VMs that do not consider actual historical operation data (e.g., usage data) of VMs.

The described technology introduces an adaptive VM uptime scheduler (AVMUS) that can modify an operating state (e.g., hibernate, deactivate, restore, reactivate, etc.) of a VM in accordance with one or more activate demand periods determined (e.g., predicted, inferred) by an agent of the VM based on historical operational data (e.g., connection times, disconnection times, application usage times, time zone data, and other operational data) of the VM. In some implementations, the agent of the VM trains a model that determines (e.g., predicts, infers) active demand periods (e.g., one or more start times and end times) for the VM based on the historical operational data. For example, a first model is trained to predict the start times of active demand periods, and a second model is trained to predict the end times of active demand periods. The agent of the VM predicts one or more active demand periods (e.g., active demand periods during the next day, week, or other predefined time period). The AVMUS modifies (e.g., modifies or schedules a modification of) the operating state of the VM in accordance with the one or more active demand periods. For example, on Tuesday, the active demand period for the VM is predicted to end at 4:00 p.m. based on actual usage data for previous Tuesdays, and, accordingly, the AVMUS deactivates or hibernates the VM at 4:00 p.m. on Tuesday. In another example, on Monday, the active demand period for the VM is predicted to start at 7:15 a.m. based on actual usage data for previous Mondays, and, accordingly, the AVMUS begins a process to reactivate or restore the VM at 7:05 a.m. on Monday so that the full functionality of the VM is available by 7:15 a.m. on Monday.

In some implementations, the AVMUS modifies a period of active demand in accordance with one or more external signals that indicate an anticipated demand or nondemand of the client computing device for the VM. For example, the AVMUS may determine an active demand period that ends at 5:00 p.m., but based on an external signal that includes a calendar event for a meeting from 5:00-6:00 p.m. that requires potential usage of the VM, the AVMUS schedules the VM to be deactivated or hibernated at 6:00 p.m. instead of at 5:00 p.m. In another example, the AVMUS may determine an active demand period that begins at 7:00 a.m. but, based on an external signal including location data indicating a current location that is a 30-minute driving distance from a typical usage location of the client computing device, the AVMUS schedules the VM to be reactivated or restored at 7:30 a.m.

Accordingly, the modification of the VM operating state of the described technology, which is based on active demand periods predicted from historical VM operational data, reduces the power usage of cloud computing systems while minimizing latencies involved in processing client computing device requests for VM processing compared to conventional load balancing schemes that merely transition VMs in and out of power-saving or cost-saving operating states at predefined periods. Further, the dynamic modification of the VM operating state of the described technology, which is based on external signals received from the client computing device that indicates an anticipated demand (or nondemand) for VM processing, also reduces the power usage of cloud computing systems while minimizing latencies involved in processing client computing device requests for VM processing compared to conventional load balancing schemes that merely implement predefined periods for various VM operating states.

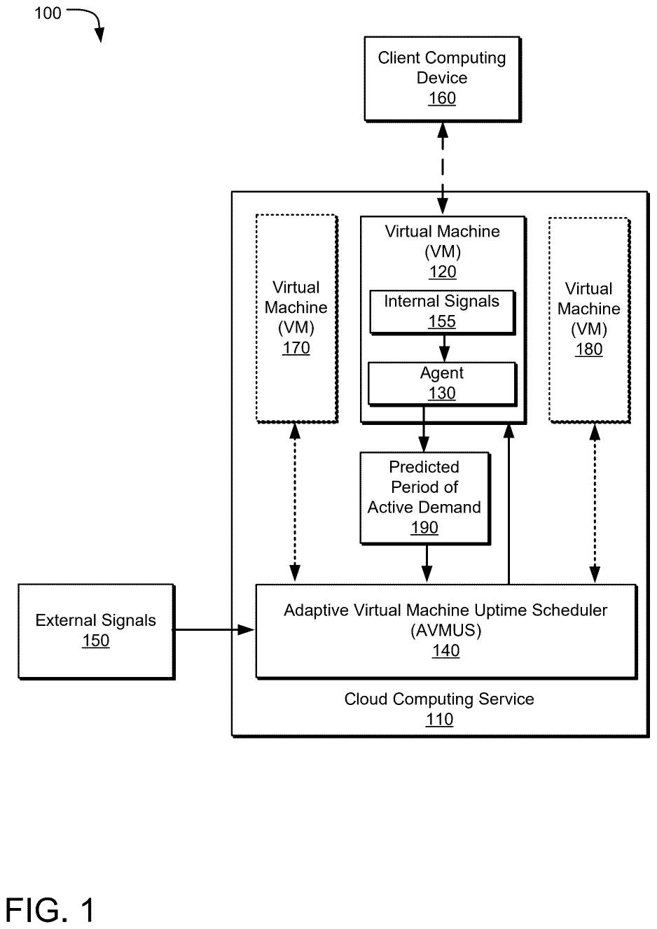

FIG. 1 illustrates an example computing environment 100 in which an adaptive VM uptime scheduler (AVMUS) 140 of a cloud computing system 110 manages an operating state of a VM 120 that is configured to connect to a client computing device 160.

The cloud computing system 110 includes computing devices that support a plurality of VMs (e.g., the VM 120, the VM 170, and the VM 180) for customers. The customers may pay for one or more of the VMs supported by the cloud computing system 110 and connect to the VMs via client computing devices (e.g., the client computing device 160). VMs (e.g., the VM 120, the VM 170, the VM 180), for example, are software-based virtual emulations of physical computers that run an operating system and applications independently of the underlying hardware that support the VMs. VMs, for example, work by using a hypervisor, a layer of software that allocates resources from the host machine's physical hardware (such as central processing unit (CPU), memory, and storage) to create isolated environments for each VM. The cloud computing system 110 may include powerful physical servers that host multiple VMs (e.g., the VM 120, the VM 170, the VM 180), enabling efficient resource sharing and scaling while maintaining separate environments for different users (e.g., a user associated with the client computing device 160) or applications. The cloud computing system 110 may include CPUs for processing, large pools of random-access memory (RAM) for fast data access, and extensive storage (such as solid-state drives (SSDs) or high-capacity hard drives) for data management. Additionally, the cloud computing system 110 may include network interface cards (NICs) for fast data transmission, graphics processing units (GPUs) for handling intensive computational tasks, and specialized hardware for security and load balancing to support multiple, isolated VM environments (e.g., the VM 120, the VM 170, the VM 180) effectively.

In some implementations, the VMs (e.g., the VM 120, the VM 170, the VM 180) supported by the cloud computing system 110 each include an agent (e.g., agent 130 of the VM 120) that monitors, detects, or otherwise determines internal signals 155 of the VM. In some implementations, a decentralized agent 130 communicates with the VMs and monitors, detects, or otherwise determines internal signals 155 of the VMs For example, internal signals 155 include connection times, disconnection times, and VM information. Connection times are times at which the client computing device 160 connects to the VM 120 of the cloud computing system 110 via a network connection. Disconnection times are times at which the client computing device 160 disconnects from the VM 120. VM information includes VM configuration parameters, for example, times at which the VM 120 transitioned to (or time periods during which the VM 120 operated in) various operating states (e.g., active, sleep, hibernating, deactivated). The VM information may include VM activity data, including the times during which (or time periods during which) the VM 120 executed particular processes and/or applications.

The agent 130 may monitor the operation of the VM 120, including its connection times, disconnection times, operating state, processes and/or applications executed, CPU utilization by one or more processes and/or applications, or other internal signals 155. Such internal signals 120 may be indicative of periods of active demand of the VM 120. Periods of active demand of the VM 120 may include periods in which the VM 120 is performing requested processing even when the VM 120 is not connected to the client computing device. In some implementations, connection and disconnection times can be associated with connection and disconnection of the VM 120 via a Remote Desktop client (RDP) or other live connection, such as a dev tunnel that provides real-time access to the VM 120 and the operations it can perform. The agent 130 may log the internal signals 155 and may store the internal signals 155 in a memory accessible to the VM 120. Based on the internal signals 155, the agent 130 predicts one or more periods of active demand for the VM 120 and transmits the predicted periods of active demand to the AVMUS 140. For example, the agent 130 may execute directly on the VM 120 and log when a client computing device connects to the VM 120 and detect a time zone of the client computing device.

In some implementations, the agent 130 queries connection and disconnection logs of the VM 120 to gather connection/disconnection data that includes the precise UTC date time stamp when a user connects and when the client computing device connects and disconnects from the VM 120. The agent 130 then removes usage that lands on particular time periods (e.g., the users'weekend). The connection/disconnection data is then cleaned up to remove disconnect events that have a subsequent connection event within a predefined amount of time (e.g., 3 hours). In some implementations, outliers are removed, where outliers may include connection sessions that continued overnight. The connection/disconnection data is then transformed to a chronologically ordered list of events with a data structure having day, start time, end time. In some implementations, if the transformed connection/disconnection data does not extend far back enough to have a threshold amount of data points for every day, the connection/disconnection data is synthesized for the days that don't have enough coverage. For example, synthesizing the data may involve propagating existing adjacent day and week data until at least a threshold amount of time (e.g., 60 days) of usage data is propagated. On systems that get regular use, such data synthesis may not occur. For example, in new systems, synthesizing usage data helps build a body of data that should work for initial predictions. In some implementations, the synthesized data is enriched with new fields (e.g., features) to yield the following fields: day, day of week, day of month, previous week start hour, previous week end hour, previous day start hour, previous day end hour, start hour, end hour. The time zone information may also be stored along with connection/disconnection data (e.g., connect and disconnect times), and the data used in the models is time-zone specific even when the VM stores the data using a standard timing convention (e.g., UTC). Connection/disconnection data logged outside of regular working hours for the user's time zone is discarded. For example, if a user connects the client computing device to the VM 120 one day at 9:00 pm to check emails and stays working for a two hours, this connection/disconnection data (e.g., connection at 9:00 p.m., disconnection at 11:00 p.m.) is discarded from the body of data used to train the model.

For example, the agent 130 trains an artificial intelligence (AI) model using the internal signals 155, for example, using historical activity data of the VM 120 and historical VM configuration parameters of the VM 120. In some implementations, in addition to or instead of determining (e.g., predicting, inferring) the one or more periods of active demand for the VM 120, the agent 130 determines one or more periods of nondemand for the VM 120. In some implementations, the agent 130 trains an AI model to predict periods of nondemand. For example, the agent 130 predicts one or more periods of active demand and/or periods of nondemand over a next predefined time period (e.g., a subsequent 12 hours, a next day, a subsequent week, etc.). In some implementations, teh AI model is a linear regression model and the linear regression model is trained for making its predictions based on an R-squared value or other statistical measure of accuracy validation. In some examples, models having the statistical measure below a threshold (e.g., R-squared value less than 0.8) are discarded and remaining models are used to generate a prediction for the next predefined time period (e.g., the next 5 days). In some implementations, the agent 130 trains a model to predict the predicted period of active demand 190 using both historical internal signals 155 and historical external signals 150. In some implementations, the AI model can be a time series prediction model, a rules-based model, a neural network, or other type of AI model. For example, AI models are algorithms or systems designed to simulate intelligent behavior, process data, and generate predictions or decisions based on that data. These models are often trained on historical data to recognize patterns, which allows them to make inferences or forecasts (e.g., predicted periods of active demand) about future events.

In some implementations, one or more operations described herein as being performed by the agent 130 may instead be performed by the AVMUS 140 or by another device or entity of the cloud computing system 110. For example, the AVMUS 140 or other entity of the cloud computing system 110, in these implementations, is able to receive or otherwise detect internal signals 155 of the VM 120 and to predict one or more periods of active demand based on the internal signals 155. In some implementations, the agent 130 transmits the internal signals 155 that it detects to the AVMUS 140, for example, when the VM 120 enters an operating state that would disable the agent 130, for example, a power-saving or cost saving operating state such as a sleep operating state, hibernating operating state, or deactivated operating state. In such implementations, the AVMUS 140 performs one or more functions of the agent 130 until the VM 120 operating state is returned to an active operating state.

The client computing device 160 may be either a physical machine in possession of an end customer (e.g., a personal compute device) or a virtual machine (VM) hosted by a cloud network. The VM 120 is configured to be connectable, in certain operating states, to the client computing device 160 to receive inputs and/or requests from the client computing device 160 and to provide outputs to the client computing device 160.

The AVMUS 140 manages the operating state of the multiple VMs (e.g., the VM 120, the VM 170, the VM 180) of the cloud computing system 110. For example, managing the operating state of the VM 120 may include transitioning the VM 120 from a first operating state to a second operating state. For example, the first operating state is one of a set of operating states. For example, the set of operating states includes an active state, a sleep state, a hibernating state, an inactive state, and other states or substates of the states as defined by the cloud computing system 110. The second operating state is another operating state (e.g., other than the first operating state) of the set of operating states. In some implementations, transitioning the VM 120 from the first operating state (e.g., hibernating operating state) to a second operating state (e.g., sleep operating state) may involve first transitioning the VM 120 to a third operating state (e.g., an active operating state) and then transitioning the VM 120 from the third operating state to the second operating state.

Transitioning the VM 120 to a sleep operating state may involve saving the current memory state of the VM 120 to random access memory (RAM). During the sleep operating state, operations of the VM 120 continue to result in some power usage (but less power usage than during a period of active demand) while the VM 120 is in the sleep operating state. Waking the VM 120 (e.g., transitioning the VM 120 from the sleep operating state to an active operating state) may involve loading the current memory state back into the physical memory of a host computing device that supports the VM 120.

Hibernating the VM 120 involves shutting down the VM 120 completely. The hibernated VM 120 may later be restored exactly where it left off without needing to restart applications or processes. When the VM 120 is hibernated, its entire state (including RAM, CPU, and device states) is saved to disk. This includes all applications, files, and processes exactly as they are. Unlike suspension (e.g., sleep operating state), which might keep some parts active on the host system, hibernation ensures the VM 120 has zero active memory footprint. Restoring the hibernating VM 120 (e.g., transitioning the VM 120 from the hibernating operating state to an active operating state) may involve loading its saved memory state and reactivating its resources to resume operations where it left off at the time hibernation began.

Deactivating the VM 120 may involve shutting down processes of the VM 120 and releasing allocated resources (e.g., a portion of the capacity of a central processing unit (CPU) and a portion of memory) of the VM 120 back to the host system (e.g., hardware device(s) supporting the VM 120). The data and configuration of the deactivated VM 120 remain intact, allowing it to be reactivated later. Hibernating the VM 120 may involve saving a current memory state of the VM 120 (e.g., to a hard drive), which preserves all active data and processes. For example, reactivating the deactivated VM 120 (e.g., transitioning the VM 120 from a deactivated operating state to an active operating state) may involve restarting the VM 120, restoring its resources (e.g., CPU, memory, etc.), reconnecting network interfaces, and/or other processes needed to restore the full functionality of the VM 120.

The AVMUS 140 receives the predicted periods of active demand (and/or predicted periods of nondemand) from agents (e.g., the agent 130) of each of the VMs (e.g., the VM 120). The predicted periods of active demand (e.g. the predicted period of active demand 190) include, for each period of active demand, a start time and/or an end time of the period of active demand. The predicted periods of active demand are determined for a predefined future period, for example, the next 12 hours, the next day, the next three days, the next week, or another predefined future period.

In some implementations, the AVMUS 140 changes an operating state or schedules a change to the operating state of one or more VMs (e.g., the VM 120) based on the predicted periods of active demand. For example, the current operating state of the VM 120 is a hibernating state, and the AVMUS 140 schedules the restoration of the VM 120 to anticipate a predicted period of active demand by a predefined amount of time (e.g., 15 minutes, 10 minutes, 5 minutes, 1 minute, or another appropriate predefined amount of time) prior to the beginning of the predicted period of active demand. For example, the AVMUS 140 may schedule the VM 120 to transition from a hibernating state to an active state at 4:55 a.m. based on a predicted period of active demand of 5:05-7:50 a.m. In another example, the AVMUS 140 may schedule the active VM 120 to transition from the active state to one of a set of power-saving or cost-saving operating states (e.g., sleep, hibernating, or deactivated operating state) at a predefined amount of time after a predicted period of active demand ends. In some implementations, the AVMUS 140 changes an operating state or schedules a change to the operating state of one or more VMs (e.g., the VM 120) based on the predicted periods of active demand and a current time. For example, at 3:00 p.m. on a first day, the AVMUS 140 may schedule the VM 120 to transition from an active state to a deactivated state at 5:05 p.m. of the subsequent day based on a predicted period of active demand of 8:52 a.m.-5:00 p.m. and a subsequent period of active demand of 9:15 a.m.-4:30 p.m. predicted to occur on the subsequent day.

In some implementations, the AVMUS 140 changes the operating state or schedules a change to the operating state of one or more VMs (e.g., the VM 120) based on one or more external signals 150. External signals 150 may include information received from the client computing device 160 to which the VM 120 is configured to be connectable. External signals 150 may include a list of applications, application data (e.g., a current route on a navigation application), times at which specific applications have been executed or interacted with by the user on the client computing device 160, location data, current time, time zone, alarm data (e.g., scheduled alarms set by the user), calendar data, scheduling application data (e.g., planned or potential meeting and event times), or client computing device 160 data. External signals 150 may include information received about a customer associated with the VM 120 and may include information from the client computing device 160 (e.g., a current location of the client computing device 160, a history of locations of the client computing device 160, calendar/meeting data, or other data from the client computing device 160), data from one or more other computing devices of the customer, or data otherwise relevant to the customer (e.g., customer account data stored by the cloud computing system 110).

The client computing device 160 or one or more computing devices (e.g., a tablet device, a mobile device, a wearable device, etc.) of the user corresponding to the client computing device 160 may, determine its current location (e.g., a longitude and a latitude) using global positioning system (GPS) or other geolocation technology, based on an address/location associated with a Wi-Fi access point or other wireless communication access point to which the client computing device 160 is connected, using carriers to determine which cell a phone is using and how far it is from neighboring cells, using compass data, accelerometer data, gyroscope data, or based on another location detection resource or function that is available to the client computing device 160 to log or otherwise detect its location.

External signals 150 may include data received from one or more devices of a user of the client computing device 160, for example, from a mobile device, a wearable device, a tablet device or other computing device of the user. For example, such external signals 150 may include location data, route data (e.g., a current route in a navigation or mapping application), biomarkers (e.g., heart rate, oxygen level, etc.), accelerometer data that indicates a speed and/or a direction of movement of the user. For example, such external signals may indicate that a user is asleep and that services of the VM 120 are not needed. External signals 150 may include data received responsive to one or more activities of a user. For example, the AVMUS 140 receives, from a computing device associated with a location (e.g., an office location) a notification that the user has entered the location responsive to the computing device scanning a badge of the user. In some instances, the AVMUS 140 changes the operating state of or schedules a change to the operating state of the VM 120 responsive to receiving a threshold number (e.g., two, three, or other number) of external signals 150. For example, the AVMUS 140 delays transitioning the VM 120 from a hibernating operating state to an active operating state during a predicted period of active demand 190 of 9:00 a.m. by one hour when the AVMUS 140 receives, at 8:45 a.m., a first external signal from a smart watch of the user of the client computing device 160 that indicates that the user is likely sleeping and a second external signal from a mobile device of the user indicating a current location outside of a predefined radius of a work station at which the client computing device 160 is located. In this example, receiving just one of the external signals would not be sufficient to delay the scheduled transition of the operating state of the VM 120.

In some implementations, the AVMUS 140 changes the operating state or schedules a change to the operating state of the VM 120 based on both the predicted periods of active demand and based on the external signals 150. For example, the AVMUS 140 may dynamically adjust a scheduled change to an operating state of a VM 120 based on received external signals 150.

For example, the AVMUS 140 schedules the VM 120 to transition from an active operating state to a hibernating operating state at 5:15 p.m. based on a period of active demand of 9:50 a.m.-5:10 p.m. predicted by the agent 130. Then, at 4:00 p.m. the same day, the AVMUS 140 receives external signals 150, including scheduling application data from the client computing device 160, indicating that the customer accepted a business meeting to occur at 5:00-7:00 p.m. the same day. For example, the business meeting would potentially require connection to and usage of the VM 120. Based on the received external signals 150, the AVMUS 140 delays the scheduled hibernation of the VM 120 from 5:15 p.m. to 7:05 p.m. so that the VM 120 will remain until accessible to the client computing device 160 during the business meeting, and no latency delay will occur for the client computing device 160.

In another example, the AVMUS 140 schedules the VM 120 to transition from an inactive operating state to an active operating state at 6:50 a.m. based on a period of active demand of 7:00 a.m.-4:30 p.m. on the same day predicted by the agent 130. Then, at 6:49 a.m. the same day, the AVMUS 140 receives external signals 150, including location data (e.g., from the client computing device 160 or from another device of the customer) indicating that the customer is an hour's trip away from a location from which the customer typically accesses the VM 120 via the client computing device 160 (e.g., the current location of the user is outside of a predefined location radius around a work station). Based on the received external signals 150, the AVMUS 140 delays the scheduled reactivation of the VM 120 by 20 minutes from 6:50 a.m. to 7:39 a.m. to minimize power usage by the VM 120 and so that it will be available to the customer when the customer is expected to arrive at the location.

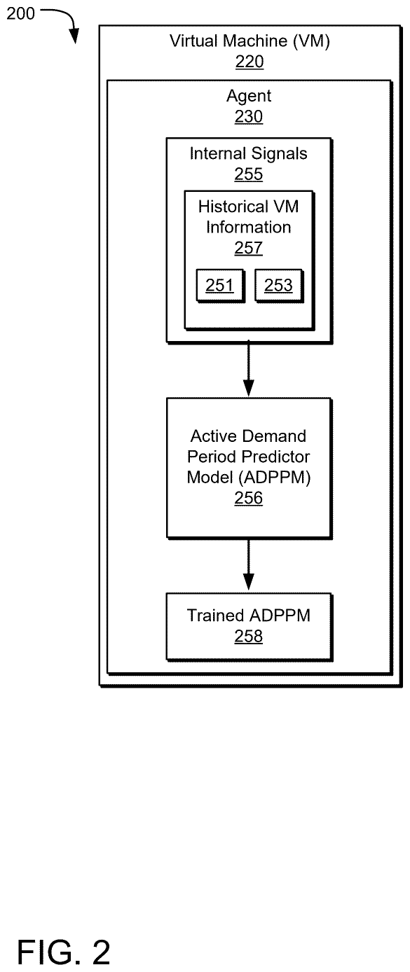

FIG. 2 illustrates an example computing environment 200 for training an active demand period predictor model (ADPPM) 256 configured to predict one or more periods of active demand of a VM 220. The computing environment 200 includes a VM 220, which includes an agent 230 that trains the ADPPM 256 to yield a trained ADPPM 258.

The agent 230 trains the ADPPM 256 using training data. The training data includes historical VM information 257, a subset of internal signals 255 of the VM 220 that are logged or otherwise detected by the VM 220. The historical VM information 257 may include historical activity data 251 of the VM 220 and historical VM configuration parameters 253 of the VM 220. The historical activity data 251 includes connection times at which the VM 220 connected to the client computing device (e.g., via one or more networks), disconnection times at which the VM 220 disconnected from the client computing device, and specific times when processes were executed by the VM 220 (e.g., times at which one or more applications, workloads, or other processes were executed on the VM 220).

The historical configuration parameters 253 include one or more of a history of the configuration of the VM 220. For example, the history of the configuration of the VM 220 may include a history of operating states (e.g., active, sleep, hibernating, deactivated, etc.) of the VM 220, a history of applications executed on the VM 220, and/or a history of client computing devices connected to the VM 220. The history of operating states may include, for a time period associated with the historical configuration parameters 253 (e.g., a past day, a past week, a past month, a past year, etc.), a time at which the VM 220 changed operating states and an identity of the operating state that the VM 220 transitioned to at each of the times. For example, the history of applications executed may include, for the time period associated with the historical configuration parameters 253, a set of time points, each of the time points including an identity of an application that the VM 220 executed at the time point. For example, the history of client computing devices connected to the VM 220 may include, for the time period associated with the historical configuration parameters 253, a list of client computing device identifiers (e.g., network identifiers) for client computing devices that the VM 220 has connected to for the time period associated with the historical configuration parameters 253.

In some implementations, during the training phase, the ADPPM 256 predicts labels comprising, for a set of historical VM information 257 associated with a particular time, one or more predicted periods of active demand for the VM 220 and compares the one or more predicted periods of active demand to corresponding ground truth values. In some implementations, training the ADPPM 256 involves minimizing a loss between the predicted periods of active demand of the VM 220 that are output by the ADPPM 256 during training and one or more corresponding ground truth values (e.g., known historical periods of active demand). For example, a predicted period of active demand is a period (e.g., a time period defined by one or more of a start time and an end time) during which the customer needs the VM 220 to be in an active operating state. The predicted period of active demand may be a period during which the customer needs the VM 220 to be in a predefined operating state (e.g., a predefined operating state selected from a set of possible operating states of the VM 220, for example, an active, sleep, hibernating, or deactivated operating state).

The trained ADPPM 258 is configured to output predicted periods of active demand for the VM 220 based on current VM information. Current VM information may be a subset of the historical VM information 257 that includes the most recent VM information. For example, the current VM information may include, as appropriate, current VM configuration parameters, including a current configuration (e.g., a current operating state) of the VM 220, an identity of applications executed on the VM 220, and one or more client computing devices connected to (or connected to within a predefined period of time from the current time) the VM 220 at a time the ADPPM 258 makes a prediction. The current VM activity data may include the most recent connection time (or disconnection time) at which the VM 220 connected to (or disconnected from) a client computing device and the identity of the client computing device. The current VM activity data may include a list of processes currently being executed by the VM 220 (e.g., identifying specific applications, workloads, or other processes currently being executed at the time the ADPPM 258 makes a prediction.

The predicted periods of active demand include, for each predicted period of active demand, a start time and/or an end time of the predicted period of active demand. The predicted periods of active demand may be determined for a predefined future period, for example, the next 12 hours, the next day, the next three days, the next week, or other predefined future period starting at the time the ADPPM 258 generates the predicted periods of active demand. The predicted period of active demand is a period (e.g., defined by one or more of a start time and an end time) during which the customer or the cloud computing system needs the VM 220 to be executing processes, to be available to execute processes, to be connected to a client computing device, to be available to be connected to a client computing device, or other predefined condition of the VM 220. The predicted periods of active demand may be predicted periods of demand (e.g., by one or more of the customer or the cloud computing system) for a predefined operating state (e.g., active, sleep, hibernating, deactivated) of the VM 220.

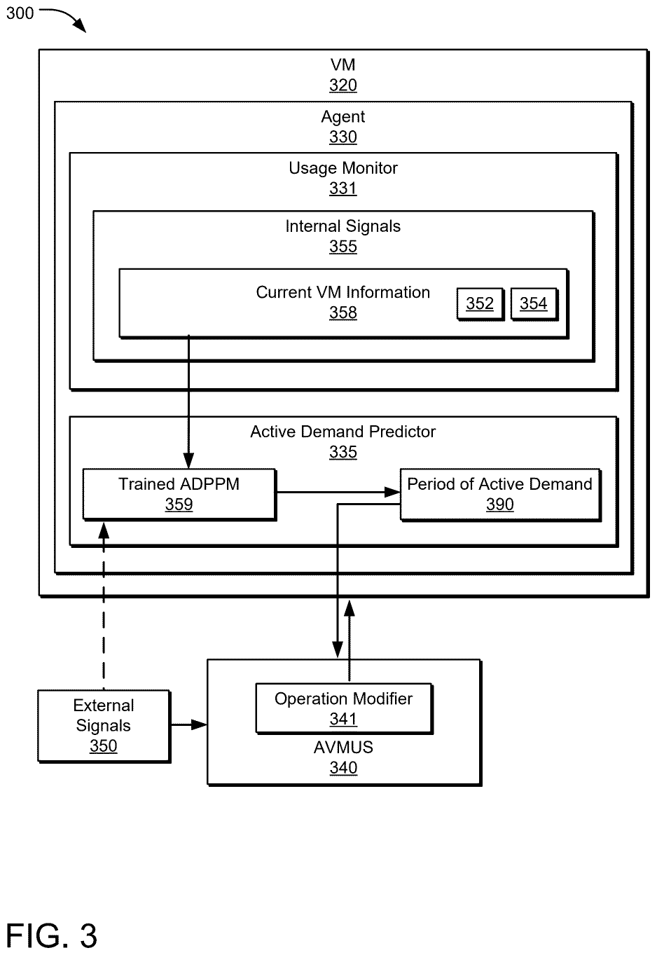

FIG. 3 illustrates an example computing environment 300 in which an adaptive VM uptime scheduler (AVMUS) 340 of a cloud computing system manages the operating state of a VM 320.

The VM 320, in some implementations, is supported by a cloud computing system. The cloud computing system provides hardware to support the VM 320. In some implementations, the cloud computing system supports multiple other VMs in addition to the VM.

The VM 320 includes an agent 330. The agent 330 includes a usage monitor 331 and an active demand predictor 335. The usage monitor 331 monitors the operation of the VM 320, including its connection times, disconnection times, operating state, processes and/or applications executed, or other internal signals 355. For example, the usage monitor 331 may log the internal signals 355 and may store the internal signals 355 in a memory accessible to the VM 320. The internal signals 355 may include historical VM information and current VM information 358. For example, the current VM information 358 is a subset of the historical VM information that includes the most recent of the historical VM information. For example, the current VM information 358 may include, as appropriate, current VM configuration parameters 352 and current VM activity data 354. The current VM configuration parameters 352 may include a current configuration (e.g., a current operating state) of the VM 320, an identity of applications executed on the VM 320, and one or more client computing devices connected to (or connected to within a predefined period of time from the current time) the VM 320 at a time the current VM information 358 is input to the trained ADPPM 359. The current VM activity data may include the most recent connection time (or disconnection time) at which the VM 320 connected to (or disconnected from) a client computing device and the identity of the client computing device. The current VM activity data 354 may include a list of processes currently being executed by the VM 320 (e.g., identifying specific applications, workloads, or other processes currently being executed at the time the current VM information is input to the trained ADPPM 359.

Based on the internal signals 355, the active demand predictor 335, the agent 330 predicts one or more periods of active demand (e.g., period of active demand 390) for the VM 320 and transmits the predicted periods of active demand to the AVMUS 340. In some implementations, the agent 330 trains a trained ADPPM 359 to predict periods of active demand (e.g., the period of active demand 390). In addition to or instead of predicting the one or more periods of active demand for the VM 320, the active demand predictor 335 may predict one or more periods of nondemand for the VM 320. The active demand predictor 335 may train a model to predict periods of nondemand. For example, the active demand predictor 335 predicts one or more periods of active demand and/or periods of nondemand over the next predefined time period (e.g., the next 12 hours, the next day, the next week, etc.). The AVMUS 340 may receive an external signal indicating a location of a user corresponding to the client computing device and may change the operating state of the virtual machine to the new operating state further based on comparing the location of the user to a location of the client computing device.

In some implementations, the active demand predictor 335 trains two linear regression machine learning models including a first linear regression model to predict a start time of the period of active demand and a second linear regression model to predict an end time of the period of active demand. The trained models may weight the most recent two weeks of usage greater than previous weeks of usage. The model training occurs locally inside the agent 330 running in the VM 320. Model validation may be performed and, if the model passes the checks, predictions for expected active periods over the next N (e.g., five or other predefined number) days are generated.

The operation modifier 341 of the AVMUS 340 manages the operating state of the VM 320, including transitioning the VM 320 between multiple possible operating states. The operation modifier 341 receives the predicted periods of active demand 390 (and/or predicted period of nondemand) from the active demand predictor 335. The operation modifier 341 may change an operating state or may schedule a change to the operating state of the VM 320 based on the predicted period of active demand 390. Once the model is trained, the models'accuracy can be determined using various methodologies (such as loss function, MAE, MSE, Rsquared, RMSE, etc), and the trained model may be discarded if usability thresholds (for example, a Rsquared value equal or greater to 0.8) are not met.

In some implementations, the operation modifier 341 changes the operating state or schedules a change to the operating state of the VM 320 based on one or more external signals 350. External signals 350 may include information received from one or more client computing devices to which the VM 320 is configured to be connectable. External signals 350 may include a list of applications, application data (e.g., a current route on a navigation application), times at which specific applications have been executed or interacted with by users of the one or more client computing devices, location data, current time, time zone, alarm data (e.g., scheduled alarms set by the user), calendar data, scheduling application data (e.g., planned or potential meeting and event times), or other client computing device data. In some implementations, external signals 350 may include information received about a customer associated with the VM 320 and may include information from the client computing device, data from one or more other computing devices of the customer, or data otherwise relevant to the customer (e.g., customer account data stored by the cloud computing system 110).

In some implementations, the operation modifier 341 changes the operating state or schedules a change to the operating state of the VM 320 based on both the predicted period of active demand 360 and based on the external signals 350. For example, the operation modifier 341 may dynamically adjust a scheduled change to an operating state of a VM 320 based on received external signals 350.

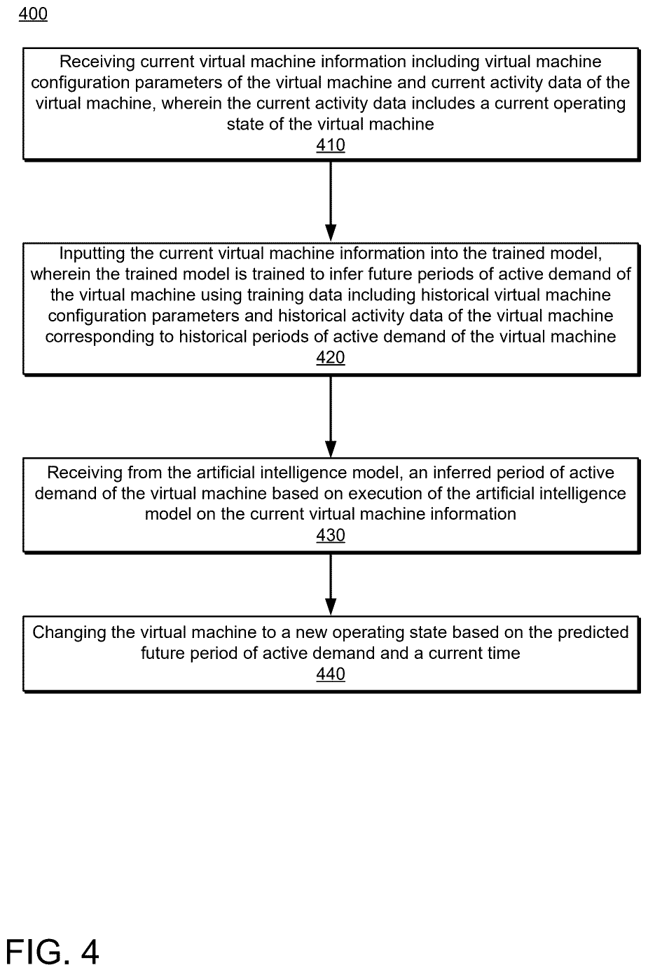

FIG. 4 illustrates examples of operations 400 for managing the operating states of a virtual machine operating on a cloud computing system.

A receiving operation 410 receives current virtual machine information, including virtual machine configuration parameters of the virtual machine and current activity data of the virtual machine, wherein the current activity data includes the current operating state of the virtual machine. In some implementations, the historical virtual machine configuration parameters include one or more of a history of operating states of the virtual machine, a history of applications executed on the virtual machine, or a history of client computing devices connected to the virtual machine. In some implementations, the historical virtual machine activity data includes connection times at which the virtual machine connected to a client computing device, disconnection times at which the virtual machine disconnected from the client computing device, and specific times when processes were executed by the virtual machine.

An inputting operation 420 inputs the current virtual machine information into the trained model, wherein the trained model is trained to predict periods of active demand of the virtual machine using training data, including historical virtual machine configuration parameters and historical activity data of the virtual machine corresponding to historical periods of active demand of the virtual machine. In some implementations, the virtual machine configuration parameters include an operating state of the virtual machine and, wherein the current activity data of the virtual machine includes one or more of the most recent connection time of the virtual machine to a client computing device or a most recent disconnection time of the virtual machine to the client computing device, and a list of processes currently being processed on the virtual machine.

A receiving operation 430 receives, from the artificial intelligence model, an inferred period of active demand of the virtual machine based on execution of the artificial intelligence model on the current virtual machine information.

A changing operation 440 from the artificial intelligence model, an inferred period of active demand of the virtual machine based on execution of the artificial intelligence model on the current virtual machine information and a current time. In some implementations, the virtual machine is in an active operating state, wherein the new operating state is in a power-saving or cost-saving operating state, wherein changing the virtual machine to the new operating state involves scheduling the change at or after an anticipated end time of the predicted period of active demand. In some implementations, the power-saving or cost-saving operating state comprises a sleep operating state, a hibernating operating state, or a deactivated operating state. In some implementations, the virtual machine is in a power-saving or cost-saving operating state, wherein the new operating state is an active operating state, wherein changing the virtual machine to the new operating state involves scheduling the change before or at an anticipated start time of the predicted period of active demand

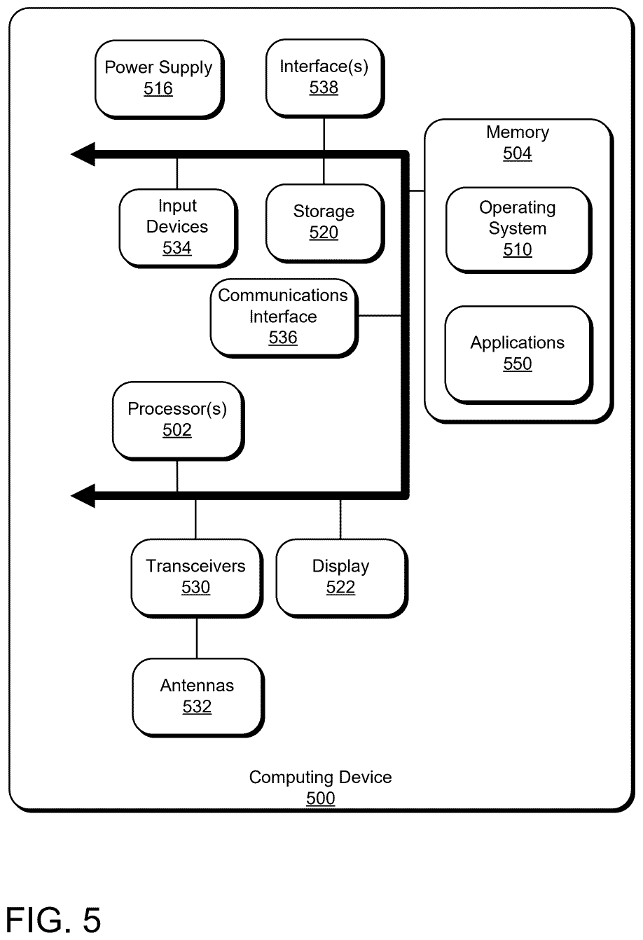

FIG. 5 illustrates an example computing device 500 for implementing the described technology. The computing device 500 may be a client computing device (such as a laptop computer, a desktop computer, or a tablet computer), a server/cloud computing device, an Internet-of-Things (IoT), any other type of computing device, or a combination of these options. The computing device 500 includes one or more hardware processor(s) 502 and a memory 504. The memory 504 generally includes both volatile memory (e.g., RAM) and nonvolatile memory (e.g., flash memory), although one or the other type of memory may be omitted. An operating system 510 resides in the memory 504 and is executed by the processor(s) 502. In some implementations, the computing device 500 includes and/or is communicatively coupled to storage 520.

In the example computing device 500, as shown in FIG. 5, one or more software modules, segments, and/or processors, such as one or more VMs, an agent, an AVMUS, an ADPPM, a usage monitor, an active demand predictor, an operation modifier, applications 550, and other program code and modules are loaded into the operating system 510 on the memory 504 and/or the storage 520 and executed by the processor(s) 502. The storage 520 may store data (e.g., including internal signals, external signals, or other data) and be local to the computing device 500 or may be remote and communicatively connected to the computing device 500. In particular, in one implementation, components of a system for reducing energy usage of a client network may be implemented entirely in hardware or in a combination of hardware circuitry and software.

The computing device 500 includes a power supply 516, which may include or be connected to one or more batteries or other power sources and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard, trackpad, or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of managing operating states of a virtual machine operating on a cloud computing system, the method comprising: receiving current virtual machine information including virtual machine configuration parameters of the virtual machine and current activity data of the virtual machine, wherein the current activity data includes a current operating state of the virtual machine; inputting the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine; receiving, from the artificial intelligence model, an inferred period of active demand of the virtual machine based on execution of the artificial intelligence model on the current virtual machine information; and changing the virtual machine to a new operating state based on the inferred period of active demand and a current time.

Clause 2. The method of clause 1, wherein changing the virtual machine to the new operating state includes scheduling a change to the operating state and modifying the operating state in accordance with the scheduled change.

Clause 3. The method of clause 1, wherein the virtual machine is in an active operating state, wherein the new operating state is in a cost saving operating state, wherein changing the virtual machine to the new operating state involves scheduling the change at or after an anticipated end time of the inferred period of active demand.

Clause 4. The method of clause 3, wherein the cost saving operating state comprises one of a sleep operating state, a hibernating operating state, or a deactivated operating state.

Clause 5. The method of clause 1, wherein the virtual machine is in a cost saving operating state, wherein the new operating state is an active operating state, wherein changing the virtual machine to the new operating state involves scheduling the change before or at an anticipated start time of the inferred period of active demand.

Clause 6. The method of clause 1, wherein the historical virtual machine configuration parameters include one or more of a history of operating states of the virtual machine, a history of applications executed on the virtual machine, or a history of client computing devices connected to the virtual machine.

Clause 7. The method of clause 1, wherein the historical virtual machine activity data includes connection times at which the virtual machine connected to a client computing device, disconnection times at which the virtual machine disconnected from the client computing device, and specific times when processes were executed by the virtual machine.

Clause 8. The method of clause 1, further comprising: receiving an external signal indicating a location of a user corresponding to a client computing device, wherein the operating state of the virtual machine is changed to the new operating state further based on comparing the location of the user to a current location of the client computing device.

Clause 9. One or more tangible processor-readable storage media embodied with instructions for executing on one or more processors and circuits of a computing device a process for managing operating states of a virtual machine operating on a cloud computing system, the process comprising: receiving current virtual machine information including virtual machine configuration parameters of the virtual machine and current activity data of the virtual machine, wherein the current activity data includes a current operating state of the virtual machine; inputting the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine; receiving, from the artificial intelligence model, an inferred period of active demand of the virtual machine based on execution of the artificial intelligence model on the current virtual machine information; and changing the virtual machine to a new operating state based on the inferred period of active demand and a current time.

Clause 10. The one or more tangible processor-readable storage media of clause 9, wherein changing the virtual machine to the new operating state includes scheduling a change to the operating state and modifying the operating state in accordance with the scheduled change.

Clause 11. The one or more tangible processor-readable storage media of clause 9, wherein the virtual machine is in an active operating state, wherein the new operating state is in a cost saving operating state, wherein changing the virtual machine to the new operating state involves scheduling the change at or after an anticipated end time of the inferred period of active demand.

Clause 12. The one or more tangible processor-readable storage media of clause 11, wherein the cost saving operating state comprises one of a sleep operating state, a hibernating operating state, or a deactivated operating state.

Clause 13. The one or more tangible processor-readable storage media of clause 9, wherein the virtual machine is in a cost saving operating state, wherein the new operating state is an active operating state, wherein changing the virtual machine to the new operating state involves scheduling the change before or at an anticipated start time of the inferred period of active demand.

Clause 14. The one or more tangible processor-readable storage media of clause 9, wherein the historical virtual machine configuration parameters include one or more of a history of operating states of the virtual machine, a history of applications executed on the virtual machine, or a history of client computing devices connected to the virtual machine.

Clause 15. A computing system for managing operating states of a virtual machine operating on a cloud computing system, the computing system comprising: one or more hardware processors; a usage monitor executable by the one or more hardware processors and configured to receive current virtual machine information including virtual machine configuration parameters of the virtual machine and current activity data of the virtual machine, wherein the current activity data includes a current operating state of the virtual machine; an active demand predictor executable by the one or more hardware processors and configured to: input the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine; and receive, from the artificial intelligence model, an inferred period of active demand of the virtual machine based on execution of the artificial intelligence model on the current virtual machine information. an operation modifier executable by the one or more hardware processors and configured to change the virtual machine to a new operating state based on the inferred period of active demand and a current time.

Clause 16. The computing system of clause 15, wherein changing the virtual machine to the new operating state includes scheduling a change to the operating state and modifying the operating state in accordance with the scheduled change.

Clause 17. The computing system of clause 15, wherein the virtual machine is in an active operating state, wherein the new operating state is in a cost saving operating state, wherein changing the virtual machine to the new operating state involves scheduling the change at or after an anticipated end time of the inferred period of active demand.

Clause 18. The computing system of clause 17, wherein the cost saving operating state comprises one of a sleep operating state, a hibernating operating state, or a deactivated operating state.

Clause 19. The computing system of clause 15, wherein the historical virtual machine configuration parameters include one or more of a history of operating states of the virtual machine, a history of applications executed on the virtual machine, or a history of client computing devices connected to the virtual machine.

Clause 20. The computing system of clause 15, wherein the virtual machine configuration parameters include an operating state of the virtual machine and wherein the current activity data of the virtual machine includes one or more of a most recent connection time of the virtual machine to a client computing device or a most recent disconnection time of the virtual machine to the client computing device, and a list of processes currently being processed on the virtual machine.

Clause 21. A system for managing operating states of a virtual machine operating on a cloud computing system, the system comprising: means for receiving current virtual machine information including virtual machine configuration parameters of the virtual machine and current activity data of the virtual machine, wherein the current activity data includes a current operating state of the virtual machine; means for inputting the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine; means for receiving, from the artificial intelligence model, an inferred period of active demand of the virtual machine based on execution of the artificial intelligence model on the current virtual machine information; and means for changing the virtual machine to a new operating state based on the inferred period of active demand and a current time.

Clause 22. The system of clause 21, wherein changing the virtual machine to the new operating state includes scheduling a change to the operating state and modifying the operating state in accordance with the scheduled change.

Clause 23. The system of clause 21, wherein the virtual machine is in an active operating state, wherein the new operating state is in a cost saving operating state, wherein changing the virtual machine to the new operating state involves scheduling the change at or after an anticipated end time of the inferred period of active demand.

Clause 24. The system of clause 23, wherein the cost saving operating state comprises one of a sleep operating state, a hibernating operating state, or a deactivated operating state.

Clause 25. The system of clause 21, wherein the virtual machine is in a cost saving operating state, wherein the new operating state is an active operating state, wherein changing the virtual machine to the new operating state involves scheduling the change before or at an anticipated start time of the inferred period of active demand.

Clause 26. The system of clause 21, wherein the historical virtual machine configuration parameters include one or more of a history of operating states of the virtual machine, a history of applications executed on the virtual machine, or a history of client computing devices connected to the virtual machine.

Clause 27. The system of clause 21, wherein the historical virtual machine activity data includes connection times at which the virtual machine connected to a client computing device, disconnection times at which the virtual machine disconnected from the client computing device, and specific times when processes were executed by the virtual machine.

Clause 28. The system of clause 21, further comprising: means for receiving an external signal indicating a location of a user corresponding to a client computing device, wherein the operating state of the virtual machine is changed to the new operating state further based on comparing the location of the user to a current location of the client computing device.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of managing operating states of a virtual machine operating on a cloud computing system, the method comprising:
receiving current virtual machine information including virtual machine configuration parameters of the virtual machine and current activity data of the virtual machine, wherein the current activity data includes a current operating state of the virtual machine;
inputting the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine;
receiving, from the artificial intelligence model, an inferred period of active demand of the virtual machine based on execution of the artificial intelligence model on the current virtual machine information; and
changing the virtual machine to a new operating state based on the inferred period of active demand and a current time.

2. The method of claim 1, wherein changing the virtual machine to the new operating state includes scheduling a change to the operating state and modifying the operating state in accordance with the scheduled change.

3. The method of claim 1, wherein the virtual machine is in an active operating state, wherein the new operating state is in a cost saving operating state, wherein changing the virtual machine to the new operating state involves scheduling the change at or after an anticipated end time of the inferred period of active demand.

4. The method of claim 3, wherein the cost saving operating state comprises one of a sleep operating state, a hibernating operating state, or a deactivated operating state.

5. The method of claim 1, wherein the virtual machine is in a cost saving operating state, wherein the new operating state is an active operating state, wherein changing the virtual machine to the new operating state involves scheduling the change before or at an anticipated start time of the inferred period of active demand.

6. The method of claim 1, wherein the historical virtual machine configuration parameters include one or more of a history of operating states of the virtual machine, a history of applications executed on the virtual machine, or a history of client computing devices connected to the virtual machine.

7. The method of claim 1, wherein the historical virtual machine activity data includes connection times at which the virtual machine connected to a client computing device, disconnection times at which the virtual machine disconnected from the client computing device, and specific times when processes were executed by the virtual machine.

8. The method of claim 1, further comprising:
receiving an external signal indicating a location of a user corresponding to a client computing device, wherein the operating state of the virtual machine is changed to the new operating state further based on comparing the location of the user to a current location of the client computing device.

9. One or more tangible processor-readable storage media embodied with instructions for executing on one or more processors and circuits of a computing device a process for managing operating states of a virtual machine operating on a cloud computing system, the process comprising:
receiving current virtual machine information including virtual machine configuration parameters of the virtual machine and current activity data of the virtual machine, wherein the current activity data includes a current operating state of the virtual machine;
inputting the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine;
receiving, from the artificial intelligence model, an inferred period of active demand of the virtual machine based on execution of the artificial intelligence model on the current virtual machine information; and
changing the virtual machine to a new operating state based on the inferred period of active demand and a current time.

10. The one or more tangible processor-readable storage media of claim 9, wherein changing the virtual machine to the new operating state includes scheduling a change to the operating state and modifying the operating state in accordance with the scheduled change.

11. The one or more tangible processor-readable storage media of claim 9, wherein the virtual machine is in an active operating state, wherein the new operating state is in a cost saving operating state, wherein changing the virtual machine to the new operating state involves scheduling the change at or after an anticipated end time of the inferred period of active demand.

12. The one or more tangible processor-readable storage media of claim 11, wherein the cost saving operating state comprises one of a sleep operating state, a hibernating operating state, or a deactivated operating state.

13. The one or more tangible processor-readable storage media of claim 9, wherein the virtual machine is in a cost saving operating state, wherein the new operating state is an active operating state, wherein changing the virtual machine to the new operating state involves scheduling the change before or at an anticipated start time of the inferred period of active demand.

14. The one or more tangible processor-readable storage media of claim 9, wherein the historical virtual machine configuration parameters include one or more of a history of operating states of the virtual machine, a history of applications executed on the virtual machine, or a history of client computing devices connected to the virtual machine.

15. A computing system for managing operating states of a virtual machine operating on a cloud computing system, the computing system comprising:
one or more hardware processors;
a usage monitor executable by the one or more hardware processors and configured to receive current virtual machine information including virtual machine configuration parameters of the virtual machine and current activity data of the virtual machine, wherein the current activity data includes a current operating state of the virtual machine;
an active demand predictor executable by the one or more hardware processors and configured to:
input the current virtual machine information into an artificial intelligence model, wherein the artificial intelligence model is trained to infer periods of active demand of the virtual machine using training data including historical virtual machine configuration parameters and historical activity data of the virtual machine corresponding to historical periods of active demand of the virtual machine; and
receive, from the artificial intelligence model, an inferred period of active demand of the virtual machine based on execution of the artificial intelligence model on the current virtual machine information;
an operation modifier executable by the one or more hardware processors and configured to change the virtual machine to a new operating state based on the inferred period of active demand and a current time.

16. The computing system of claim 15, wherein changing the virtual machine to the new operating state includes scheduling a change to the operating state and modifying the operating state in accordance with the scheduled change.

17. The computing system of claim 15, wherein the virtual machine is in an active operating state, wherein the new operating state is in a cost saving operating state, wherein changing the virtual machine to the new operating state involves scheduling the change at or after an anticipated end time of the inferred period of active demand.

18. The computing system of claim 17, wherein the cost saving operating state comprises one of a sleep operating state, a hibernating operating state, or a deactivated operating state.

19. The computing system of claim 15, wherein the historical virtual machine configuration parameters include one or more of a history of operating states of the virtual machine, a history of applications executed on the virtual machine, or a history of client computing devices connected to the virtual machine.

20. The computing system of claim 15, wherein the virtual machine configuration parameters include an operating state of the virtual machine and wherein the current activity data of the virtual machine includes one or more of a most recent connection time of the virtual machine to a client computing device or a most recent disconnection time of the virtual machine to the client computing device, and a list of processes currently being processed on the virtual machine.
